(19) United States
(12) Patent Application Publication
(10) Pub. No.: US 2012/0096998 A1
(43) Pub. Date: Apr. 26, 2012

(54) Lifting device for self-adjusting locking pliers

(76) Inventor: Shin-An Shih, Taichung (TW)

(21) Appl. No.: 12/909,862

(22) Filed: Oct. 22, 2010

(51) Int. Cl. B25B 29/00

(52) U.S. Cl. 81/488

(57) ABSTRACT

A lifting device includes two opposite parallel rings; and a bridge member interconnecting the rings, the bridge member comprising a through hole having a diameter greater than that of a threaded shank of a thumb screw. Threaded shank of the thumb screw is adapted to drive through the through hole into a threaded hole in a rear end of a stationary handle of a self-adjusting locking pliers to rotatably retain the lifting device.

### FIELD OF THE INVENTION

The invention relates to locking pliers and more particularly to a ring shaped lifting device which can be fastened at a rear end of a stationary handle of a self-adjusting locking pliers by driving a thumb screw through itself into a threaded hole in the rear end of the stationary handle so that the locking pliers, having its jaws lockingly gripping an object, is ready to be hanged in a hoisting operation.

### DESCRIPTION OF RELATED ART

A typical locking pliers 6 may have a threaded hole 6a in a rear end of a stationary handle as shown in FIG. 1. A ring 1 is integrally formed with a threaded shank 2 which is adapted to drive into the threaded hole 6a by threading so that a hook, having one end attached to, for example, a wire rope, may be put on the ring 1 in a hoisting operation.

Another typical locking pliers 6 may have a threaded hole 6a in a rear end of a stationary handle as shown in FIG. 2. A hook 3 is integrally formed with a threaded shank 5 which is adapted to drive into the threaded hole 6a by threading so that a wire rope may be put on the hook 3 in a hoisting operation. Additionally, a pivotal safety latch 4 is provided at the mouth 3a of the hook 3 to prevent the wire rope from disengagement.

However, the threaded fastening of each of the above two typical devices is not reliable because the threaded shank may be disengaged from the threaded hole as time evolves. Thus, the need for improvement still exists.

### SUMMARY OF THE INVENTION

It is therefore one object of the invention to provide a lifting device for a self-adjusting locking pliers including a stationary handle and a thumb screw, comprising two opposite parallel rings; and a bridge member interconnecting the rings, the bridge member comprising a through hole having a diameter greater than that of a threaded shank of the thumb screw, wherein the threaded shank of the thumb screw is adapted to drive through the through hole into a threaded hole in a rear end of the stationary handle to rotatably retain the lifting device.

The above and other objects, features and advantages of the invention will become apparent from the following detailed description taken with the accompanying drawings.

### BRIEF DESCRIPTION OF THE DRAWINGS

FIG. 1 is a side elevation of a rear end of a stationary handle of a typical locking pliers being threadedly secured to a threaded shank which is attached to a ring;

FIG. 2 is a side elevation of a rear end of a stationary handle of another typical locking pliers being threadedly secured to a threaded shank which is attached to a hook;

FIG. 3 is a perspective view of a self-adjusting locking pliers incorporating a lifting device according to a first preferred embodiment of the invention;

FIG. 4 is an exploded perspective view of the locking pliers with both the lifting device and the thumb screw detached;

FIG. 5 is a side elevation in part section of the locking pliers of FIG. 3 showing the threaded fastening of the lifting device by driving the thumb screw through itself into the threaded hole in the rear end of the stationary handle;

FIG. 6 is an enlarged view in part section of the fastened portion of FIG. 5;

FIG. 7 is a rear end view of FIG. 6;

FIG. 8 is a view similar to FIG. 7 showing 360-degree rotation of the lifting device;

FIG. 9 is an exploded perspective view of a self-adjusting locking pliers incorporating a lifting device according to a second preferred embodiment of the invention;

FIG. 10 is a side elevation in part section of the locking pliers of FIG. 9 showing the threaded fastening of the lifting device by driving the thumb screw through itself into the threaded hole in the rear end of the stationary handle;

FIG. 11 is a perspective view of a lifting device according to a third preferred embodiment of the invention;

FIG. 12 is a side elevation in part section of the locking pliers of FIG. 11 showing the threaded fastening of the lifting device by driving the thumb screw through itself into the threaded hole in the rear end of the stationary handle; and

FIG. 13 is a perspective view showing the lifting device according to the first preferred embodiment of the invention secured to a self-adjusting locking pliers having its jaws gripping an object and hanged on a hook which is in turn at an end of a chain in a hoisting operation.

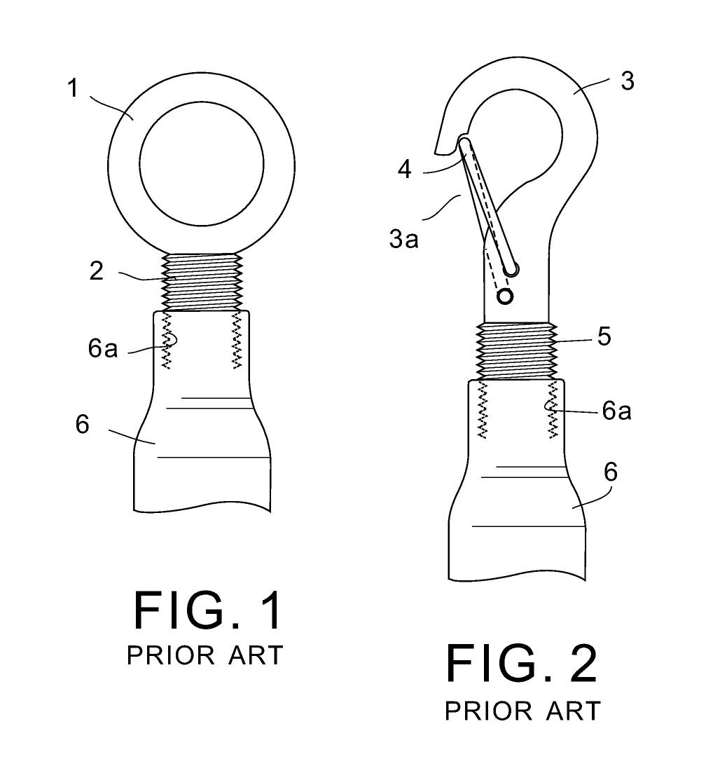

### DETAILED DESCRIPTION OF THE INVENTION

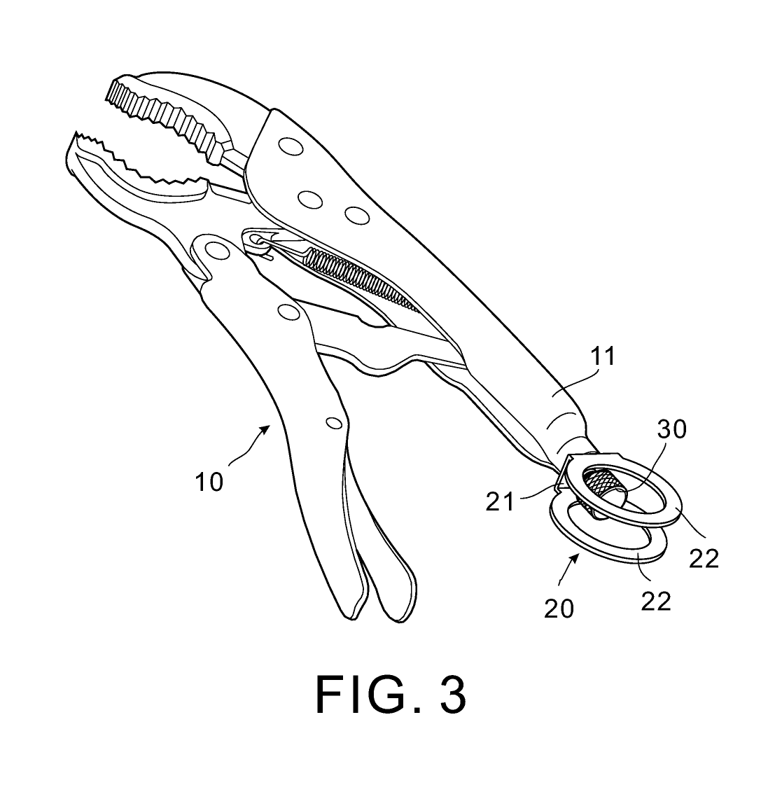

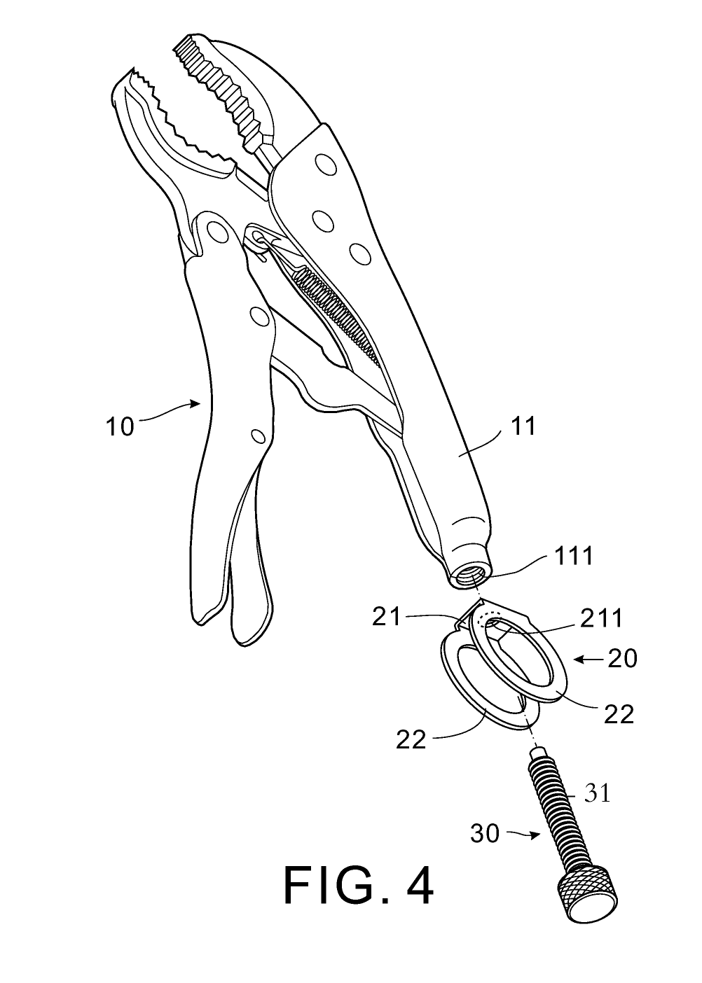

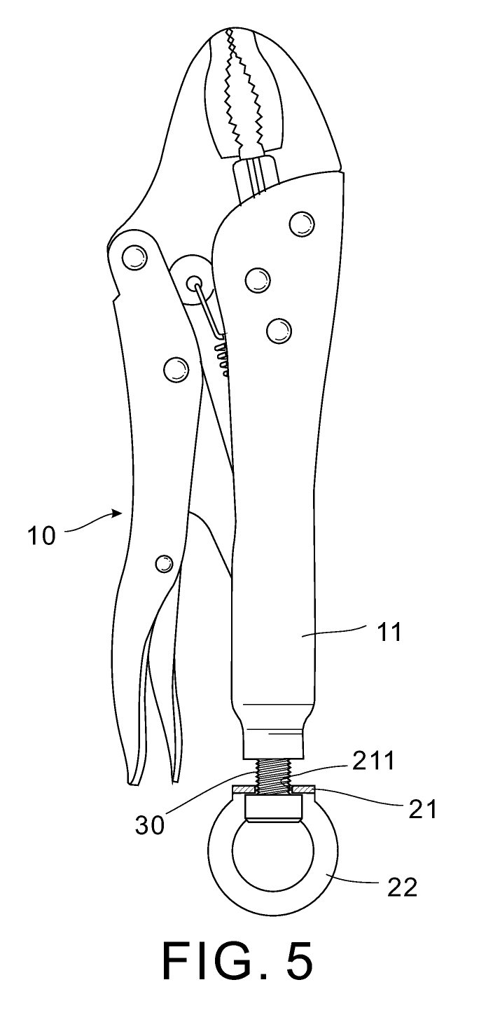

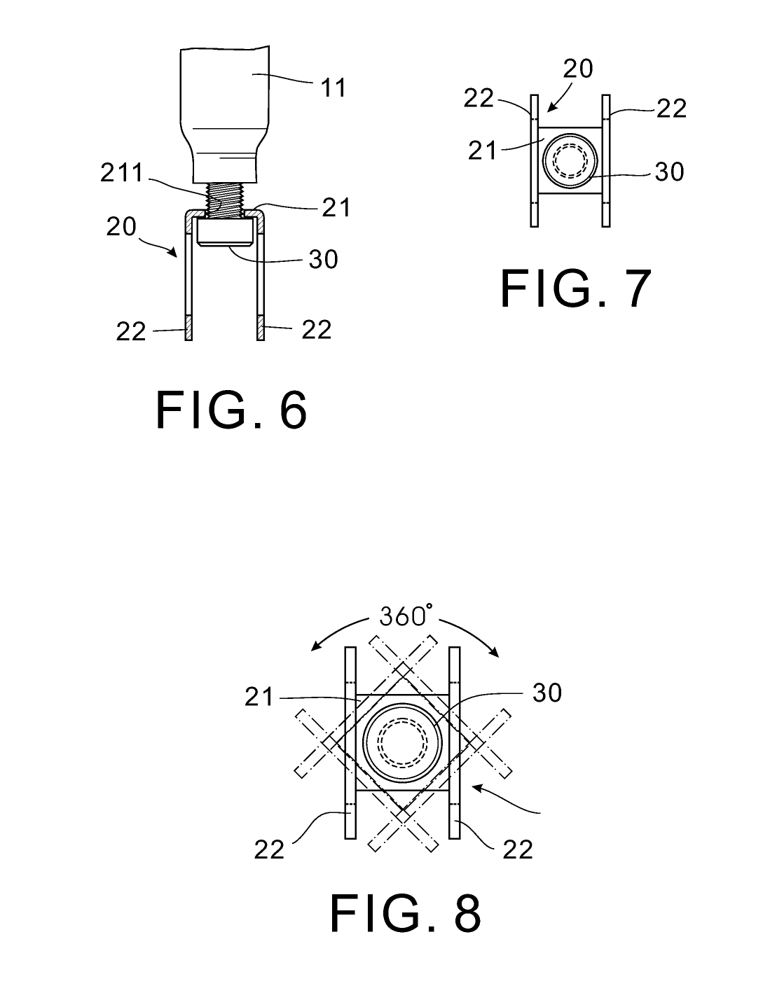

Referring to FIGS. 3 to 8, a lifting device 20 in accordance with a first preferred embodiment of the invention is adapted to be attached to a rear end of a stationary handle 11 of a self-adjusting locking pliers 10 as detailed below.

The lifting device 20 is shaped as a yoke and comprises two opposite parallel rings 22 of the same size and a rectangular bridge member 21 interconnecting the rings 22, the bridge member 21 having a through hole 211. A threaded shank 31 of a thumb screw 30 can be driven through the through hole 211 into a threaded hole 111 in the rear end of the stationary handle 11. Bore of the through hole 211 is slightly greater than the diameter of the threaded shank 31 of the thumb screw 30. Thus, in the fastened position of the thumb screw 30 the lifting device 20 can freely turn about the thumb screw 30 (see FIG. 8).

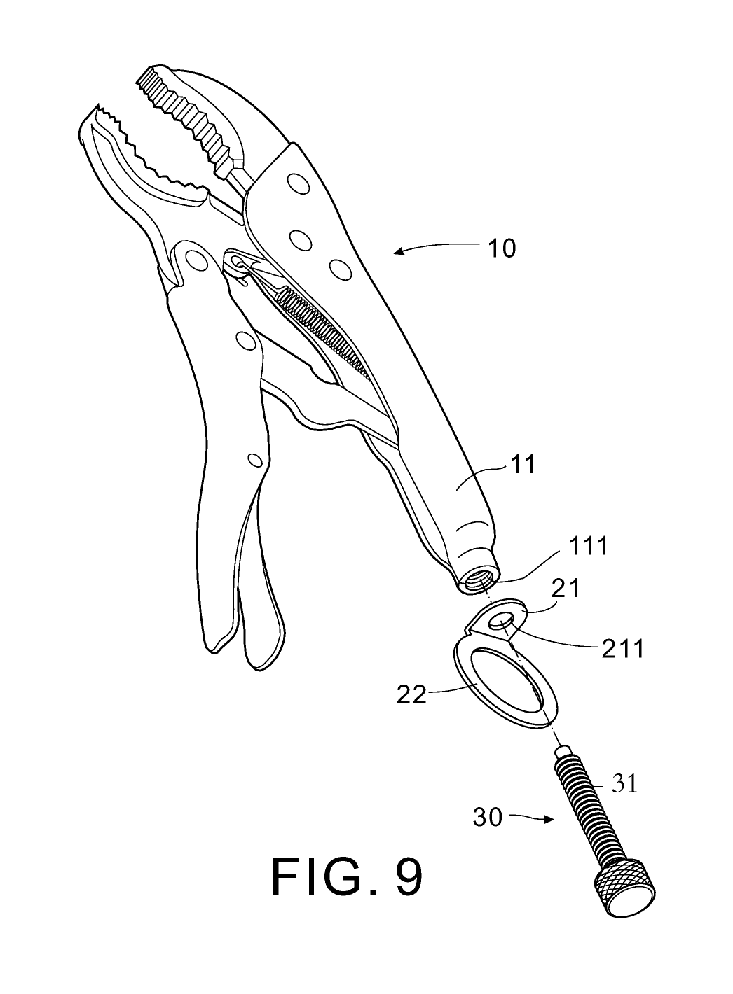

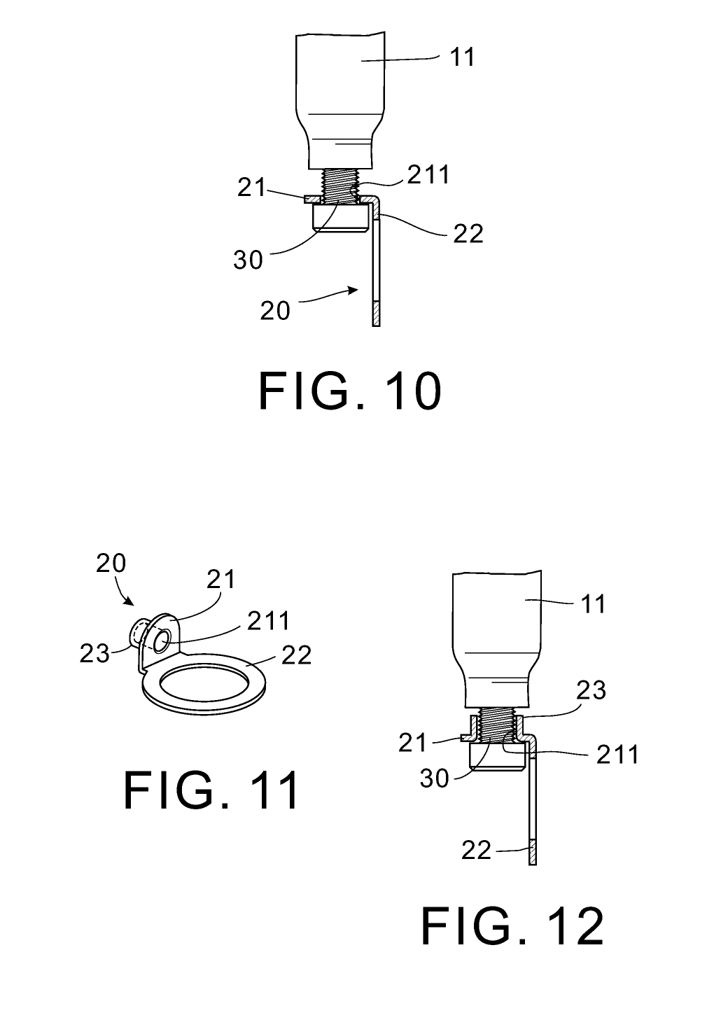

Referring to FIGS. 9 and 10, a lifting device 20 in accordance with a second preferred embodiment of the invention is adapted to be attached to a rear end of a stationary handle 11 of a self-adjusting locking pliers 10 as detailed below.

The lifting device 20 comprises a ring 22 and a bridge member 21 projecting out of an outer edge of the ring 22 and bent about 90-degree with respect to the ring 22, the bridge member 21 having a through hole 211. A threaded shank 31 of a thumb screw 30 can be driven through the through hole 211 into a threaded hole 111 in the rear end of the stationary handle 11. Bore of the through hole 211 is slightly greater than the diameter of the threaded shank 31 of the thumb screw 30. Thus, in the fastened position of the thumb screw 30 the lifting device 20 can freely turn about the thumb screw 30.

Referring to FIGS. 11 and 12, a lifting device 20 in accordance with a third preferred embodiment of the invention is adapted to be attached to a rear end of a stationary handle 11 of a self-adjusting locking pliers 10 as detailed below.

The lifting device 20 comprises a ring 22, a bridge member 21 projecting out of an outer edge of the ring 22 and bent about 90-degree with respect to the ring 22, the bridge member 21 having a through hole 211, and a hollow, short cylindrical member 23 formed integrally with the through hole 211. Also, bore of the cylindrical member 23 is the same as the diameter of the through hole 211. The threaded shank of a thumb screw 30 can be driven through the through hole 211 and the cylindrical member 23 into a threaded hole in the rear end of the stationary handle 11. Bore of each of the through hole 211 and the cylindrical member 23 is slightly greater than the diameter of the threaded shank of the thumb screw 30. Thus, in the fastened position of the thumb screw 30 the lifting device 20 can freely turn about the thumb screw 30.

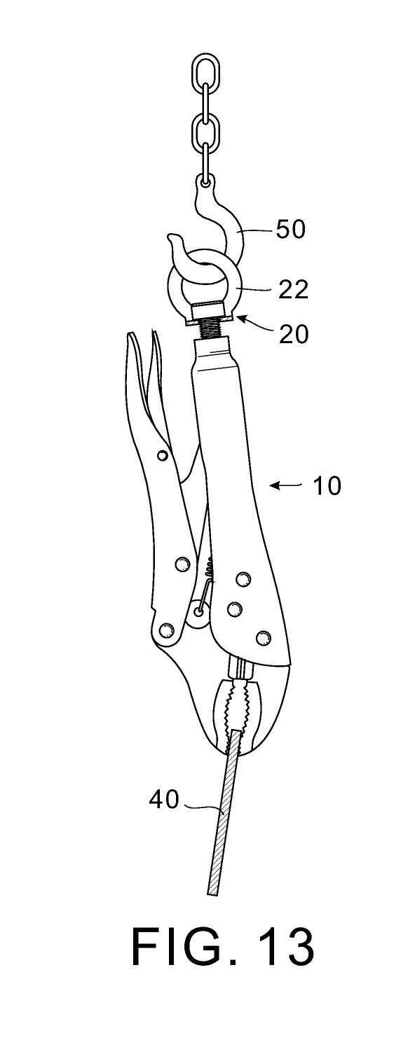

Referring to FIG. 13, it shows the lifting device 20 according to the first preferred embodiment of the invention secured to a self-adjusting locking pliers 10 having its jaws gripping an object 40. Also, the rings 22 of the lifting device 20 are hanged on a hook 50 which is in turn at an end of a chain in a hoisting operation.

While the invention has been described in terms of preferred embodiments, those skilled in the art will recognize that the invention can be practiced with modifications within the spirit and scope of the appended claims.

What is claimed is:

1. A lifting device for a self-adjusting locking pliers including a stationary handle and a thumb screw, comprising:
two opposite parallel rings; and
a bridge member interconnecting the rings, the bridge member comprising a through hole having a diameter greater than that of a threaded shank of the thumb screw,
wherein the threaded shank of the thumb screw is adapted to drive through the through hole into a threaded hole in a rear end of the stationary handle to rotatably retain the lifting device.
